(19) United States
(12) Patent Application Publication
(10) Pub. No.: US 2006/0244725 A1
(43) Pub. Date: Nov. 2, 2006

(54) Cursor control device having multiplex control function key

(75) Inventors: Chin-Kuan Lou, Taipei (TW); Tzu-Chiang Shih, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/156,281

(22) Filed: Jun. 17, 2005

(30) Foreign Application Priority Data
Apr. 29, 2005 (TW) 094113810

(51) Int. Cl. G09G 5/08

(52) U.S. Cl. 345/163

(57) ABSTRACT

The present invention relates to a cursor control device capable of controlling corresponding movements of the vertical scroll bar and the horizontal scroll bar on the computer screen. Furthermore, the cursor control device is very user-friendly and advantageous for facilitating the user to select functions switched between several operating modes without largely increasing the keys' number.

### FIELD OF THE INVENTION

The present invention relates to a cursor control device, and more particularly to a cursor control device having a multiplex control function key.

### BACKGROUND OF THE INVENTION

In views of the technical development of the cursor control device such as a computer mouse, the photosensing technology is more critical for increasing application and function of the cursor control device.

As known, when the conventional computer mouse is operated, only the vertical scroll bar displayed on a digital display device such as a computer screen is moved in the vertical direction. The horizontal scroll bar, however, fails to be moved in the horizontal direction.

An input device including a wheel assembly for scrolling an image in multiple directions is described in U.S. Pat. No. 6,700,564, which is hereby fully incorporated by reference. By rotating the scroll wheel leftwards or rightwards, the horizontal scroll bar shown on the computer screen will be located to move in the left or right direction.

Since the above approach needs complicated hardware configuration, the cost relating to this improvement is increased and this approach is disadvantageous for mass production.

On the other hand, with rapid development of the multimedia device, another type of conventional cursor control device has additional multimedia control function keys thereon in addition to the common cursor control functions. Take the computer mouse for example. Since the computer mouse is not very bulky but two group of respective control function keys (for example a group of the cursor control function keys and the other group of the multimedia control function keys) should be arranged on the housing thereof, the operating interface for control of the computer mouse would be quite large. This operating interface becomes hindrance from using the computer mouse because it has complicated design and is not user-friendly enough.

In views of the above-described disadvantages resulted from the prior art, the applicant keeps on carving unflaggingly to develop a cursor control device having a multiplex control function key according to the present invention through wholehearted experience and research.

### SUMMARY OF THE INVENTION

It is an object of the present invention to provide a cursor control device for controlling corresponding movements of the vertical scroll bar and the horizontal scroll bar on the computer screen.

Another object of the present invention is to provide a user-friendly cursor control device to facilitate the user to select functions switched between several operating modes without largely increasing the keys' number.

In accordance with a first aspect of the present invention, there is provided a cursor control device having a multiplex control function key. The cursor control device comprises a cursor control main body and a multiplex control functional unit. The cursor control main body comprises a left-side control function key, a right-side control function key and a scroll wheel disposed between the left-side control function key and the right-side control function key. The multiplex control functional unit is adjacent to the left-side control function key, the right-side control function key and the scroll wheel, and generates an operating mode switching signal in response to a switching operation. The left-side control function key, the right-side control function key and multiplex control functional unit are all operated in a cursor operating mode when the operating mode switching signal is in a first signal state. The left-side control function key, the right-side control function key and multiplex control functional unit are all operated in other operating mode different from the cursor operating mode when the operating mode switching signal is in a second signal state.

In an embodiment, the multiplex control functional unit comprises a mode switching key and a four-directional control function key. The mode switching key is adjacent to the left-side control function key and the right-side control function key, and generates the operating mode switching signal according to different signal states in response to the switching operation. The four-directional control function key is adjacent to the mode switching key, and provides control functions required for different operation modes when the operating mode switching signal is in the first and second operating states.

In an embodiment, the four-directional control function key comprises four control function keys adjacent to and disposed on the upper, lower, left and right regions of the mode switching key, respectively, so as to cooperatively form a five-directional mini-joystick along with the mode switching key. The control function keys on the left and right regions of the mode switching key provide horizontal moving functions of a horizontal scroll bar, the control function keys on the upper and lower regions of the mode switching key provide page up and page down functions, respectively, and the left-side control function key, the right-side control function key provide functions similar to those of a regular mouse.

In an embodiment, the other operating mode different from the cursor operating mode is a multimedia operating mode.

In an embodiment, the control function keys on the left and right regions of the mode switching key provide leftward and rightward moving functions of a multimedia device, respectively, the control function keys on the upper and lower regions of the mode switching key provide volume up and volume down functions of the multimedia device, respectively, and the left-side control function key and the right-side control function key provide play and pause functions of the multimedia device, respectively.

In an embodiment, the multiplex control functional unit further comprises a mute control function key to provide a mute function of the multimedia device.

In an embodiment, any two control function keys are disposed on left and right regions of the mode switching key, respectively, and the other two control function keys are both disposed on an upper or lower region of the mode switching key. Alternatively, any two control function keys are disposed on upper and lower regions of the mode switching key, respectively, and the other two control function keys are both disposed on a left or right region of the mode switching key.

In an embodiment, the other operating mode different from the cursor operating mode is a program control operating mode.

Preferably, the program control operating mode includes an EXCEL program control mode or a WORD program control mode.

In an embodiment, the scroll wheel provides moving function of a vertical scroll bar in a vertical direction.

In accordance with a second aspect of the present invention, there is provided a multiplex control functional unit arranged on a cursor control device. The cursor control device includes a cursor control main body, a scroll wheel, a left-side control function key and a right-side control function key. The multiplex control functional unit comprises a mode switching key and plural control function keys. The mode switching key is disposed on a surface of a housing of the cursor control main body, and generates an operating mode switching signal in response to a switching operation such that the cursor control main body is operated in either of at least two operating modes including a cursor operating mode. The plural control function keys are disposed on the surface of the housing of the cursor control main body. At least one of the plural control function keys is enabled to provide multiplex control functions required for different operation modes including a cursor operating mode when the operating mode switching signal is in different operating states.

In accordance with a third aspect of the present invention, there is provided a cursor control device having a multiplex control function key. The cursor control device comprises a cursor control main body, a mode switching key and plural control function keys. The cursor control main body has a scroll wheel on a surface of a housing thereof for controlling movement of a cursor, wherein the scroll wheel provides moving function of a vertical scroll bar in a vertical direction. The mode switching key is disposed on the surface of the housing of the cursor control main body, and generates an operating mode switching signal in response to a switching operation such that the cursor control main body is operated in either of at least two operating modes including a cursor operating mode. The plural control function keys are disposed on the surface of the housing of the cursor control main body. In an embodiment, at least four of the plural control function keys are enabled to provide multiplex control functions required for different operation modes including a cursor operating mode when the operating mode switching signal is in different operating states.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a cursor control device according to a first preferred embodiment of the present invention;

FIG. 2 is a schematic view illustrating a varied cursor control device of FIG. 1, in which the four directional control function keys are also disposed at the upper region of the left-side control function key and the right-side control function key;

FIG. 3 is a schematic view illustrating another varied cursor control device of FIG. 1, in which the four directional control function keys are also disposed at the upper region of the left-side control function key and the right-side control function key; and

FIG. 4 is a schematic view illustrating a cursor control device according to a second preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The principal concept of the present invention is implemented by employing a mode switching key to provide multiplex control functions to a portion or all of the limited number of function keys on the surface of the cursor control device. In such way, the cursor control device is capable of controlling corresponding movement of the horizontal scroll bar and facilitating the user to select functions switched between several operating modes without largely changing the hardware configuration and increasing the keys' number, thereby meeting the requirement of cursor control.

In accordance with a preferred embodiment of the present invention, an operating interface capable of providing several operating functions, for example a mini-joystick or touch pad, is installed on the surface of the cursor control device so as to implement the concept. Afterwards, by means of software settings, a certain key is preset to provide the operating mode switching function. The rest of the additional keys and the original control function keys for controlling the cursor movement are cooperatively formed as the cursor control device having a multiplex control function key.

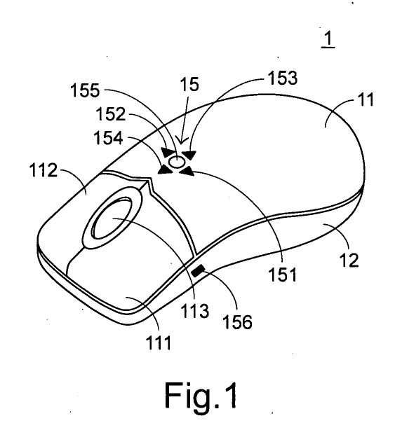

Referring to FIG. 1, a schematic view of a cursor control device according to a first preferred embodiment of the present invention is illustrated. An exemplary cursor control device 1 is a computer mouse. The computer mouse 1 has a cursor control main body including an upper housing 11, a lower housing 12 and a photosensing module (not shown) between the upper housing 11 and the lower housing 12. The computer mouse 1 further comprises a left-side control function key 111 and a right-side control function key 112 arranged on the front end of the upper housing 11. A scroll wheel 113 is disposed between the left-side control function key 111 and the right-side control function key 112 to control movement of the on-screen vertical scroll bar (not shown) in the vertical direction.

The computer mouse 1 further comprises a multiplex control functional unit 15 disposed at the upper region of the left-side control function key 111 and the right-side control function key 112. The multiplex control functional unit 15 comprise four directional control function keys 151˜154 and a mode switching key 155. The mode switching key 155 is designed to generate different operating mode switching signals according to different operating states. The four directional control function keys 151˜154 are employed to provide different control functions required for different operations when the operating mode switching signals are in first and second operating states. For example, by triggering the mode switching key 155, the computer mouse 1 is switched between a cursor operating mode and a multimedia operating mode. In this circumstance, the four directional control function keys 151˜154 are utilized to provide multiplex control functions in different operating modes. In the multimedia operating mode, a multimedia device (not shown) is controlled to perform the multimedia functions. An example of the multimedia device includes DVD player software or song player software.

Alternatively, each of the left-side control function key 111 and the right-side control function key 112 may be designed as a multiplex control function key. In other words, each of the left-side control function key 111 and the right-side control function key 112 is employed to provide different control functions required for different operations when the operating mode switching signals are in first and second operating states.

In an embodiment, the operation mechanisms of the mode switching key 155 of the computer mouse 1 is designed to be switched between a cursor operating mode and a multimedia operating mode, which will be described in more details as follows.

(1) In the cursor operating mode, the left-side control function key 111 and the right-side control function key 112 provide functions similar to the left button and the right button of a general computer mouse, respectively. The scroll wheel 113 provides the up/down moving functions of the vertical scroll bar. The control function keys 151 and 152 provide leftward and rightward moving functions of the horizontal scroll bar, respectively. The control function keys 153 and 154 provide the page up and page down functions, respectively.

(2) In the multimedia operating mode, the left-side control function key 111 and the right-side control function key 112 provide play/pause functions of the multimedia device, respectively. Likewise, the scroll wheel 113 provides the up/down moving functions of the vertical scroll bar. The control function keys 151 and 152 provide forward and backward moving functions of the multimedia device, respectively. The control function keys 153 and 154 provide the volume up and volume down functions, respectively.

The multiplex control functional unit 15 further comprises a mute control function key 156 disposed at a lateral side of the lower housing 12. When the mute control function key 156 is enabled in the multimedia operating mode, a mute control function is imparted to the computer mouse 1.

That is to say, by means of the mode switching key 155, the computer mouse 1 can be selectively operated in the cursor operating mode or the multimedia operating mode. The instruction associated with the function of the related keys in one of the cursor operating mode and the multimedia operating mode would be displayed on the computer screen in real time when suitable software is cooperatively executed. In this circumstance, the user is notified how to operate the mode switching key 155. It is noted that, however, those skilled in the art will readily observe that numerous modifications and alterations of the respective multiplex function may be made while retaining the teachings of the invention. For example, according to the practical requirement the respective multiplex function can be designed with software. Accordingly, the above disclosure should be limited only by the bounds of the following claims.

The corresponding signals generated in response to user's actuation on the function keys of the multiplex control functional unit 15 may be transmitted to a control device (not shown) built in a computer. An example of the control device is a south bridge chip. Similar to the communication between a general computer mouse and the computer, the signals from the multiplex control functional unit 15 can be transmitted to the control device via a serial RS-232 port or the common USB transmission interface. Afterward, according to execution of a specific software program, the control operations corresponding to these function keys will be implemented in response to these generated signals.

The hardware configuration of the mini-joystick or touch pad and the method for installing the mini-joystick or touch pad on the cursor control main body are known to the art, and are not to be redundantly described herein.

Furthermore, the mode switching key 155 of the computer mouse 1 is not limited to be switched between the cursor operating mode and the multimedia operating mode. Alternatively, by using the mode switching key 155, the computer mouse 1 may be switched between the cursor operating mode and a program control operating mode. An example of the program control operating mode includes an EXCEL program control mode or a WORD program control mode.

The cursor control main body can be a trackball mouse or an optical mouse. Alternatively, the cursor control main body can be a wired mouse or a wireless mouse.

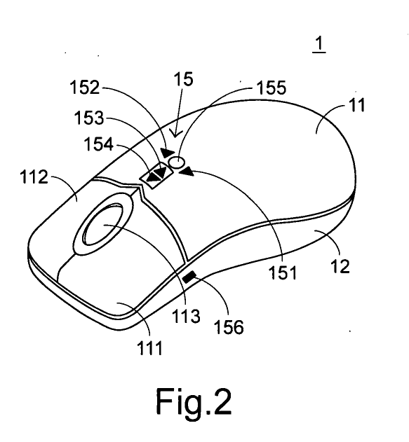

The locations of the four directional control function keys 151˜154 relative to the mode switching key 155 may be varied according to the manufacturer's design. Referring to FIG. 2, the four directional control function keys 151˜154 are also disposed at the upper region of the left-side control function key 111 and the right-side control function key 112. The control function keys 151 and 152 are located at the left and right sides of the mode switching key 155, respectively, while the control function keys 153 and 154 are disposed at the lower region of the mode switching key 155.

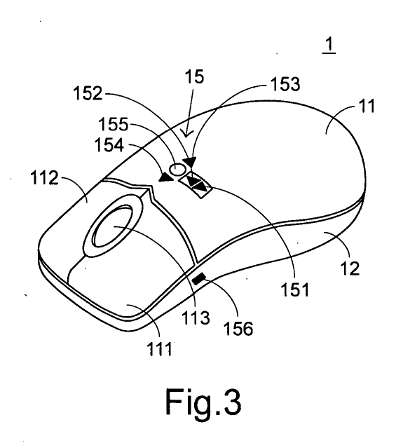

In the embodiment of FIG. 3, the four directional control function keys 151˜154 are also disposed at the upper region of the left-side control function key 111 and the right-side control function key 112. The control function key 153 is disposed at the upper region of the mode switching key 155, while the control function key 154 is disposed at the lower region of the mode switching key 155. The control function keys 151 and 152 are both located at the left sides of the mode switching key 155.

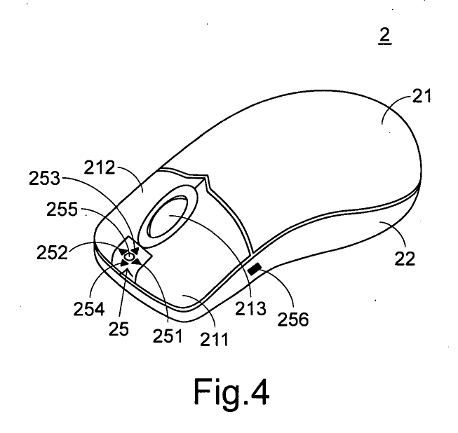

Referring to FIG. 4, a schematic view of a cursor control device according to a second preferred embodiment of the present invention is illustrated. The cursor control device 2 is for example a computer mouse and comprises an upper housing 21, a lower housing 22, a scroll wheel 213, a left-side control function key 211, a right-side control function key 212 and a multiplex control functional unit 25. The multiplex control functional unit 25 includes a mode switching key 255 and a mute control function key 256. Since the operation principles of the elements included therein are similar to those shown in FIG. 1, and are not to be redundantly described herein. In contrast, in the embodiment of FIG. 4, the four directional control function keys 251˜254 are disposed at the lower region of the left-side control function key 111 and the right-side control function key 112, thereby facilitating the user to operate the cursor control device 2.

From the above description, the cursor control device of the present invention is capable of controlling corresponding movements of the vertical scroll bar and the horizontal scroll bar on the computer screen. In addition, the cursor control device is very user-friendly and advantageous for facilitating the user to select functions switched between several operating modes without largely increasing the keys' number.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cursor control device having a multiplex control function key, comprising:
a cursor control main body comprising a left-side control function key, a right-side control function key and a scroll wheel disposed between said left-side control function key and said right-side control function key; and
a multiplex control functional unit adjacent to said left-side control function key, said right-side control function key and said scroll wheel, and generating an operating mode switching signal in response to a switching operation;
wherein said left-side control function key, said right-side control function key and multiplex control functional unit are all operated in a cursor operating mode when said operating mode switching signal is in a first signal state, and said left-side control function key, said right-side control function key and multiplex control functional unit are all operated in other operating mode different from said cursor operating mode when said operating mode switching signal is in a second signal state.

2. The cursor control device according to claim 1 wherein said multiplex control functional unit comprises:
a mode switching key adjacent to said left-side control function key and said right-side control function key, and generating said operating mode switching signal according to different signal states in response to said switching operation; and
a four-directional control function key adjacent to said mode switching key, and providing control functions required for different operation modes when said operating mode switching signal is in said first and second operating states.

3. The cursor control device according to claim 2 wherein said four-directional control function key comprises four control function keys adjacent to and disposed on the upper, lower, left and right regions of said mode switching key, respectively, so as to cooperatively form a five-directional mini-joystick along with said mode switching key, wherein said control function keys on said left and right regions of said mode switching key provide horizontal moving functions of a horizontal scroll bar, said control function keys on said upper and lower regions of said mode switching key provide page up and page down functions, respectively, and said left-side control function key, said right-side control function key provide functions similar to those of a regular mouse.

4. The cursor control device according to claim 2 wherein said other operating mode different from said cursor operating mode is a multimedia operating mode.

5. The cursor control device according to claim 4 wherein said control function keys on said left and right regions of said mode switching key provide leftward and rightward moving functions of a multimedia device, respectively, said control function keys on said upper and lower regions of said mode switching key provide volume up and volume down functions of said multimedia device, respectively, and said left-side control function key and said right-side control function key provide play and pause functions of said multimedia device, respectively.

6. The cursor control device according to claim 5 wherein said multiplex control functional unit further comprises a mute control function key to provide a mute function of said multimedia device.

7. The cursor control device according to claim 2 wherein said four-directional control function key comprise four control function keys adjacent to said mode switching key, wherein any two control function keys are disposed on left and right regions of said mode switching key, respectively, and the other two control function keys are both disposed on an upper or lower region of said mode switching key, or wherein any two control function keys are disposed on upper and lower regions of said mode switching key, respectively, and the other two control function keys are both disposed on a left or right region of said mode switching key.

8. The cursor control device according to claim 1 wherein said other operating mode different from said cursor operating mode is a program control operating mode.

9. The cursor control device according to claim 8 wherein said program control operating mode includes an EXCEL program control mode or a WORD program control mode.

10. The cursor control device according to claim 1 wherein said scroll wheel provides moving function of a vertical scroll bar in a vertical direction.

11. A multiplex control functional unit arranged on a cursor control device including a cursor control main body, a scroll wheel, a left-side control function key and a right-side control function key, said multiplex control functional unit comprising:
a mode switching key disposed on a surface of a housing of said cursor control main body, and generating an operating mode switching signal in response to a switching operation such that said cursor control main body is operated in either of at least two operating modes including a cursor operating mode; and
plural control function keys disposed on said surface of said housing of said cursor control main body, wherein at least one of said plural control function keys is enabled to provide multiplex control functions required for different operation modes including a cursor operating mode when said operating mode switching signal is in different operating states.

12. The multiplex control functional unit according to claim 11 wherein said plural control function keys comprise four control function keys disposed around said mode switching key.

13. The multiplex control functional unit according to claim 12 wherein said four control function keys are adjacent to and disposed on the upper, lower, left and right regions of said mode switching key, respectively, so as to cooperatively form a five-directional mini-joystick along with said mode switching key, wherein said control function keys on said left and right regions of said mode switching key provide cursor control functions required for operation in said cursor operating mode when said operating mode switching signal is in a first signal state, and said control function keys on said left and right regions of said mode switching key provide multimedia control functions required for operation in a multimedia operating mode when said operating mode switching signal is in a second signal state.

14. The multiplex control functional unit according to claim 13 wherein said multiplex control functional unit further comprises a mute control function key to provide multimedia control functions required for operation in said multimedia operating mode when said operating mode switching signal is in said second signal state.

15. The multiplex control functional unit according to claim 12 wherein any two of said four control function keys are disposed on left and right regions of said mode switching key, respectively, and the other two control function keys are both disposed on an upper or lower region of said mode switching key, or wherein any two of said four control function keys are disposed on upper and lower regions of said mode switching key, respectively, and the other two control function keys are both disposed on a left or right region of said mode switching key.

16. The multiplex control functional unit according to claim 11 wherein said other operating mode different from said cursor operating mode is a program control operating mode.

17. The multiplex control functional unit according to claim 16 wherein said program control operating mode includes an EXCEL program control mode or a WORD program control mode.

18. The multiplex control functional unit according to claim 11 wherein said scroll wheel provides moving function of a vertical scroll bar in a vertical direction.

19. A cursor control device having a multiplex control function key, comprising:
a cursor control main body having a scroll wheel on a surface of a housing thereof for controlling movement of a cursor, wherein said scroll wheel provides moving function of a vertical scroll bar in a vertical direction;
a mode switching key disposed on said surface of said housing of said cursor control main body, and generating an operating mode switching signal in response to a switching operation such that said cursor control main body is operated in either of at least two operating modes including a cursor operating mode; and
plural control function keys disposed on said surface of said housing of said cursor control main body, wherein at least four of said plural control function keys are enabled to provide multiplex control functions required for different operation modes including a cursor operating mode when said operating mode switching signal is in different operating states.

20. The cursor control device according to claim 19 wherein said at least two operating modes includes said cursor operating mode and a multimedia operating mode, wherein said plural control function keys comprise a left-side control function key, a right-side control function key, a four-directional control function key adjacent to said mode switching key, and a mute control function key to provide multimedia control functions required for operation in said multimedia operating mode when said operating mode switching signal is in a second signal state.
